(19) United States
(12) Patent Application Publication
(10) Pub. No.: US 2006/0203757 A1
(43) Pub. Date: Sep. 14, 2006

(54) Adaptive repeater system

(75) Inventors: Shane Young, Nepean (CA); Colin Kellett, Ramsbury (GB); Mike Roper, Ottawa (CA); Steve Allen, Ottawa (CA); Wagdy Hanna, Ottawa (CA); Paul Simpson, Lanark (CA)

Correspondence Address: PEARNE & GORDON LLP, 1801 EAST 9TH STREET, SUITE 1200, CLEVELAND, OH, 44114-3108, US

(73) Assignee: Spotwave Wireless Inc., Ottawa (CA)

(21) Appl. No.: 11/078,110

(22) Filed: Mar. 11, 2005

(51) Int. Cl. H04J 3/08

(52) U.S. Cl. 370/315

(57) ABSTRACT

A repeater system of a wireless network includes at least one adaptive repeater module and a personality module. The adaptive repeater module includes a hardware signal path for processing an input RF signal to generate a corresponding output RF signal; and a controller unit including a micro-processor for controlling parameters of the hardware signal path in accordance with a software program. The personality module is removably connectable to the adaptive repeater module, and includes a computer readable medium for storing the software program.

### CROSS-REFERENCE TO RELATED APPLICATIONS

This is the first application filed for the present invention.

### TECHNICAL FIELD

The present application relates to wireless access networks and, in particular, to an adaptive repeater system.

### BACKGROUND OF THE INVENTION

Repeaters are well known in the art for amplifying and retransmitting an input signal. In some cases, various types of active circuitry may also be used to enhance the signal-to-noise (S/N) ratio, in addition to simply increasing the power level. A typical application of repeaters is for improving wireless services within defined regions of a wireless network, where signal levels (or Signal-to-noise—S/N ratio) would otherwise be too low for satisfactory quality of service.

For example, within a building or a built-up urban area, signal attenuation, shadowing by buildings and/or hills, noise and multi-path effects can seriously degrade the quality of desired RF signals. Installation of a repeater covering the affected area can improve access to wireless services, by boosting the power level of the desired RF signals. A wireless network provider may also install a repeater in order to improve service in a region lying at an edge of the coverage area serviced by a base station, thereby effectively extending the reach of the base-station.

FIG. 1 is a block diagram schematically illustrating principal components of a conventional repeater. As may be seen in FIG. 1, a conventional repeater generally comprises a hardware signal path 2 extending between input and output antennas 4 & 6; and a control unit 8 for controlling parameters of the hardware signal path 2. External RF signals Se and feedback signals Sf (from the output antenna 6) are received by the input antenna 4 as an input RF signal Si. The input signal Si is processed (i.e. amplified and filtered) through the hardware signal path 2 to produce an output RF signal So, which is retransmitted by the output antenna 6.

It will be noted that FIG. 1 shows a single hardware signal path 2, which processes RF signals in one direction (e.g. uplink or downlink) only. Typically, a repeater will be designed to process RF signals in both directions simultaneously. As is well known in the art, bi-directional signal processing can easily be accommodated by providing a pair of hardware signal paths (one for each direction). In some cases, each signal path is provided with it own set of input and output antennas. In others, a single pair of antennas is provided, with each antenna being connected to both hardware paths via diplexer (not shown). In either case, it is customary to provide a common control unit, which controls operation of both signal paths. All of these arrangements are well known in the art, and will not be described or illustrated herein. For clarity of illustration only, only one hardware signal path is shown in FIG. 1, it being understood that a second signals path to convey RF signal in the opposite direction would normally be provided.

As may be seen in FIG. 1, the hardware signal path 2 generally provides a cascade of fixed and variable gain amplifiers, and filters. The amplifiers provide the system gain which makes the repeater useful. The filters improve the signal-to-noise ratio and limit the center frequency and bandwidth of the hardware signal path 2. It is frequently desirable to perform the amplification and filtering operations at a frequency that is lower than that of the input RF signal Si. Accordingly, repeaters commonly combine the input RF signal Si with a local oscillator signal (LO1), to downconvert the input RF signal Si to an intermediate frequency (or baseband) signal. At the output end of the hardware signal path 2, the processed IF (or baseband) signal is combined with a second local oscillator signal (LO2), to produce the output RF signal So. In cases where LO1 and LO2 have the same frequency, the output RF signal So will have the same center frequency as the input signal Si, in which case the repeater is commonly referred to as a “same-frequency” or “on-frequency” repeater. In cases where LO1 and LO2 have different frequencies, the center frequency of the output RF signal So will be offset from the input signal Si.

The control unit 8 typically comprises a mix of analog and digital circuitry (not shown) for controlling parameters of the hardware signal path 2, and thereby the performance and behavior of the repeater. Path parameters that are typically controlled include path gain; pass-band center frequency (via control of the LO1 frequency); and output signal center frequency (via control of the LO2 frequency), In addition, methods are known for controlling the pass-band width, and the stability margin.

Typically, pass-band width is controlled by processing the input signal Si through a cascade of mixers supplied by a respective controllable local oscillator signal and fixed pass-band filters (not shown), and then controlling the respective frequencies of each of the local oscillators. The combined response of the cascade is a pass-band having a bandwidth governed by the frequency offset between the various local oscillator signals.

Stability margin is normally controlled by detecting the antenna isolation (which can be derived from the strength of the feedback signal Sf in the input RF signal Si), and then setting a maximum permissible path gain to guarantee stability. Typically, this operation is performed by a trained technician during installation of the repeater. However, since the mount of antenna isolation can change over time (sometimes quite dramatically), this upper gain limit must necessarily be based on a conservative estimate of what the “worst case” isolation is likely to be during subsequent operation. It has long been recognized that this may result in the upper gain limit being set at a level significantly below that which would be optimum most of the time.

In an effort to address this problem, it is known to provide the control unit 8 with an automatic stability management system (not shown), which operates to detect incipient oscillation, and reduce the path gain as needed to ensure stability. Typically, this involves transmitting a pilot or probe signal from the output antenna 6, and then detecting it in input signal Si. The signal power of the detected probe signal is then compared to one or more threshold values, and the path gain (or, in some systems, the maximum permissible gain) is varied in accordance with the comparison result. In some cases, this operation is conducted by a “hardwired” controller made up of a combination of digital and analog circuitry. In other cases, a microprocessor operates under software control to perform the necessary operations.

A limitation of conventional repeaters, is that the combination of center frequency and bandwidth will normally be specific to a particular carrier, service and geographical region. For example, each carrier (i.e. wireless service provider) operating within a particular region (e.g. a city or other service area) is assigned a particular portion of the RF spectrum, and a unique channel for control channel signaling. These assignments will be normally unique to reach carrier and type of wireless service (TDMA, GSM, CDMA etc), and may vary from one region to another—even for the same carrier/service combination. In the current North American wireless market, this results in over 400 different carrier/service/region combinations, each of which requires a unique set of repeater control parameters. Compounding this situation is the necessity for adjusting the repeater during installation to accommodate the unique RF environment in which it is installed, for example by setting the maximum gain to prevent instability, as described above.

In order to provide the necessary degree of flexibility, the control unit 8 is typically provided with a set of Dual In-line Pin (DIP) switches 10 which control the various parameters of the hardware signal path 2, and thereby the performance and behavior of the repeater. With this arrangement, a technician can determine the appropriate parameter settings (e.g. for bandwidth, center frequency and frequency offset) for a particular carrier/service/region combination, and then select the appropriate DIP switch states to provide those settings. The technician can then measure antenna isolation, and determine the maximum permissible gain to ensure stability and, if applicable, threshold values for controlling an automatic stability management system. These parameters can then be set, again by selecting appropriate states of DIP switches provided for that purpose.

This arrangement suffers numerous disadvantages. For example, since the RF environment of each repeater is unique, the combination of DIP switch states for every repeater will also be unique. This means that the installation of each repeater must be performed by a highly trained technician, using specialized equipment. This dramatically increases the cost of installation. Furthermore, the use of DIP switches imposes a practical limit on the number of parameters that can be controlled, and the degree of control that may be available. As may be appreciated, increasing the number of parameters and/or degree of control produces a corresponding increase in the number of required DIP switches, which increases the complexity of system set-up and the probability of error.

A repeater system that avoids at least some of the foregoing deficiencies, at a moderate costs remains highly desirable.

### SUMMARY OF THE INVENTION

An object of the present invention is to provide a universal repeater system that can be installed with minimal intervention from a trained technician.

Accordingly, an aspect of the present invention provides a repeater system of a wireless network. The repeater system comprises at least one adaptive repeater module and a personality module. The adaptive repeater module includes a hardware signal path for processing an input RF signal to generate a corresponding output RF signal; and a controller unit including a micro-processor for controlling parameters of the hardware signal path in accordance with a software program. The personality module is removably connectable to the adaptive repeater module, and includes a computer readable medium for storing the software program.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating principal elements and operation of a conventional repeater;

FIG. 2 is a block diagram schematically illustrating principal elements and operation of an adaptive repeater system in accordance with a first embodiment of the present invention;

FIG. 3 is a block diagram schematically illustrating principal elements and operation of an adaptive repeater system in accordance with a second embodiment of the present invention;

FIGS. 4a and 4b schematically illustrate respective embodiments of the present invention in which multiple adaptive coverage modules are connected to a single adaptive donor module using cascaded and parallel connection schemes, respectively;

FIG. 5 is a block diagram schematically illustrating an adaptive repeater module in accordance with a further embodiment of the present invention;

FIG. 6 is a block diagram schematically illustrating operation of a repeater system in accordance with the present invention, utilizing donor and coverage area variants of the adaptive repeater module of FIG. 5;

FIG. 7 is a block diagram schematically illustrating a variant of the adaptive repeater module of FIG. 5; and

FIG. 8 is a block diagram schematically illustrating an adaptive repeater module in accordance with a further embodiment of the present invention.

It will be noted that throughout the appended drawings, like features are identified by like reference numerals.

### DETAILED DESCRIPTION OF PREFERRED EMBODIMENTS

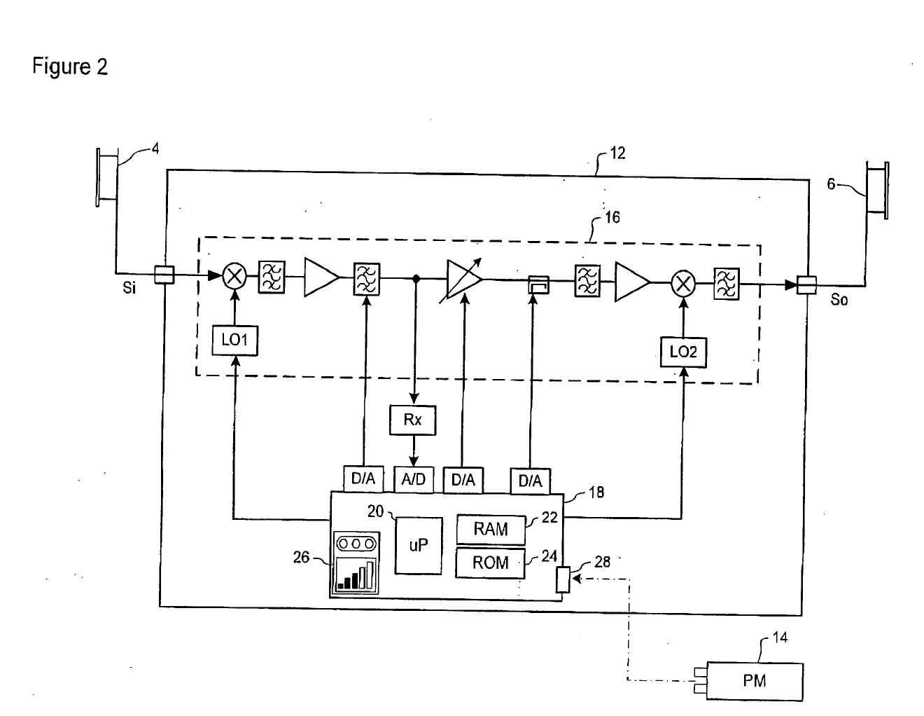

The present invention provides an adaptive repeater system that can be installed in any desired location with minimal intervention by a trained technician. Embodiments of the present invention are described below with reference to FIGS. 2-8.

As shown in FIG. 2, an adaptive repeater system in accordance with the present invention generally comprises an adaptive repeater module 12 and a personality module (PM) 14. The adaptive repeater module 12 generally comprises a hardware signal path 16 and a controller unit 18. The hardware signal path 16 operates in a generally conventional manner to process (e.g. amplify and filter) an input RF signal Si to generate a corresponding output RF signal So. The controller unit 18 is preferably an entirely digital system connected to the hardware signal path 18 via analog-to-digital (A/D) and digital-to-analog (D/A) converters, and comprises a microprocessor 20 and appropriate volatile and non-volatile memories 22, 24. A display 26, which may include LED and bar-graph indicators (and/or other types of indicators such as audio enunciators, not shown) can also be provided, and driven by the microprocessor 20. A PM port 28 provides a bus connection between the controller unit 18 and the personality module 14. Various standard data ports (interfaces) may be used for this purpose, including, Universal Serial Bus (USB) and Personal Computer Memory Card Interface Association (PCMCIA) interfaces. The microprocessor 20 operates under software control to govern the performance and behaviour of the hardware signal path 16, and thus the repeater system as a whole, as will be described in greater detail below.

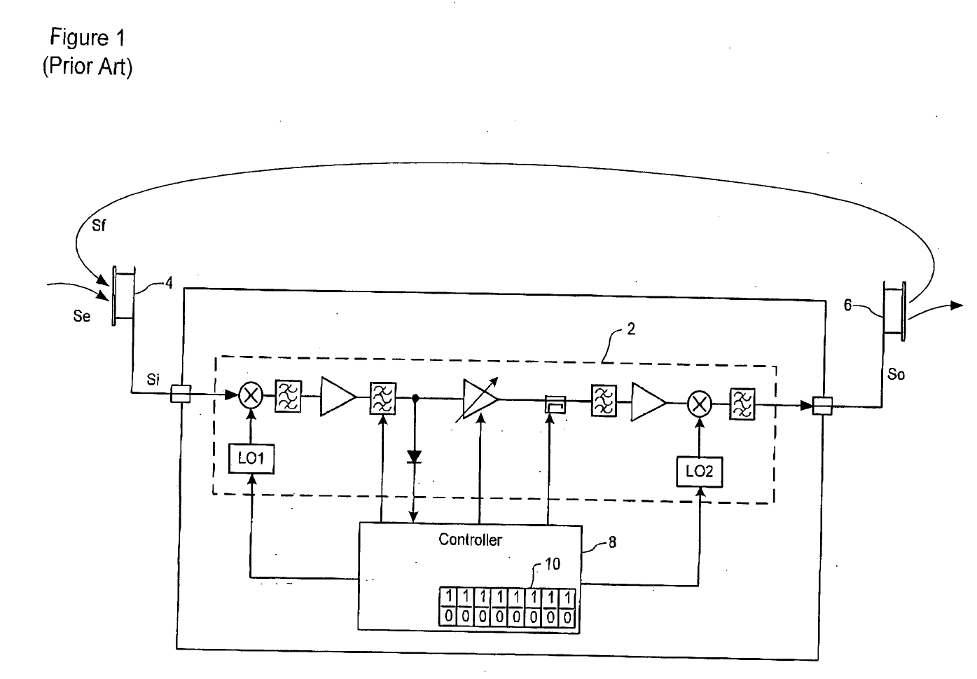

As with FIG. 1, for the sake of clarity of illustration only, FIGS. 2-8 show only one hardware signal path 16 conveying Rf signals in one direction (i.e. uplink or downlink). It will be understood, however, that the present invention contemplates that respective hardware signal paths 16 will be provided to process RF signals in both directions simultaneously. It is also contemplated that a common controller unit 18 will be used to control both signal paths 16. Since both signal paths require closely similar signal processing and control functionality, it is expected that the person of ordinary skill in the art will be readily capable of extending the teaching herein to cover practical repeater systems having two hardware signal paths for simultaneously processing RF signals in both the uplink and downlink directions.

The personality module 14 generally comprises a non-volatile memory, such as a FLASH-RAM, and is designed to be removably connected to the control unit 18 via the PM port 28. In general, the personality module 14 is used to store the parameters and software used by the control unit 18 to govern the performance and behaviour of the adaptive repeater system, as will be described in greater detail below. If desired, the personality module 14 may also include an authentication engine, which may also include encryption, for controlling use of the parameters and software stored thereon. For example, the authentication engine could use a system identifier stored in the non-volatile memory 24 of the controller unit 16 to verify that the software and parameters stored on the personality module 14 are appropriate for that specific adaptive repeater system. This may be used, for example, to ensure that the correct parameters and software are loaded into each adaptive repeater system and to prevent unauthorised access to (and use of) the parameters and software stored on the PM. Thus for example, a customer can be prevented from using a single personality monitor 14 with multiple adaptive repeater systems.

In one aspect of the invention, the software includes a parameter list providing settings for each of the parameters of the hardware signal path 16. By this means, all of the path parameters can be fixed by the software. Consequently, a respective parameters list can be compiled for each carrier/service/region combination. Since these combinations are known in advance, the parameters lists can be complied and stored, for example in a database. Configuring the repeater to operate within any one carrier/service/region can then be accomplished by loading the appropriate parameters list, which thereby effectively eliminates the need for DIP switches.

A further advantage of this arrangement is that parameter settings can be dynamically adjusted, during run-time, in accordance with the software. Those of ordinary skill in the art will appreciate that a virtually unlimited variety of algorithms may be implemented, subject primarily to the computational power of the microprocessor 20 and the amount of available memory. Thus, for example, an algorithm may be executed, on system power-up, to “boot-strap” the repeater by detecting a base-station of the wireless network, and setting an initial value of the path gain and (possibly) other parameters. During subsequent run-time operation, another algorithm can be executed to detect antenna isolation, dynamically optimize path gain and unconditionally guarantee stability. Taken together, these algorithms effectively eliminate the need for a technician to measure antenna isolation and set maximum gain during system installation. It will be appreciated that software control of repeater performance in this manner affords a dramatically greater degree of adaptability of the repeater system than is practicable in conventional (DIP switch controlled) repeaters.

In accordance with an aspect of the present invention, the software used to control the repeater system is divided between the controller unit 18 (i.e. the non-volatile memory 24) and the personality module 14. In particular, the software used to control the adaptive repeater system may usefully be divided into “low-level” firmware, and “high-level” software.

The high-level software is stored on the personality module 14, and governs all of the functionality needed to operate the adaptive repeater module 12 as an operative repeater system. At a minimum, this includes the parameters list appropriate to the carrier/service/region in which the repeater system will operate, as well as software code implementing adaptive control algorithms for dynamic performance optimization during run-time.

Low-level firmware is stored in the non-volatile memory 24 of the controller unit 18, and governs basic functionality, such as, for example:
detecting and triggering execution of the high-level software from the PM 14. For example, the controller 18 can be designed to detect the insertion of a personality module 14 into the PM port 28. This event triggers execution of firmware code that locates and loads the parameters list to establish the appropriate performance parameters of the hardware signal path 16. The firmware code can then locate and trigger execution of the high-level software, either directly from the personality module 14, or after loading the high-level software into the control unit's volatile memory 22.
Illuminating the LED indicator and bar-graph of the display 26 in response to the high-level software provided by the personality module 14. For example, software code implementing adaptive control algorithms operate to detect both antenna isolation and the power level of the input signal Si. Digital samples indicative of the detected quantities can then be supplied to the firmware, which drives the LED indicator to show antenna isolation, and the bar-graph display to show received signal power.
   These and other low-level functions of the firmware will be described in greater detail below.

As may be appreciated, dividing the control software in the above manner provides a number of advantages. For example:
The adaptive repeater module is rendered “universal”, in that the same module 12 can be installed in every carrier/service/region. The “customization” required for the module 12 to operate successfully for that context, and in the particular RF environment in which it is installed, is provided by the parameters list and software stored on the personality module 14. This enables economies of scale to be achieved in the manufacture of the repeater module 12, thereby lowering unit costs.
The adaptive repeater module 12 can be manufactured, tested and shipped to local distributors independently of the personality module 14, because the low-level firmware enables the repeater system to “self-boot” and locate the PM 14 at the time of actual installation of the repeater system.
installation of the adaptive repeater module 12 can be accomplished without specialized training and equipment, because the high-level software stored on the PM 14 detects received signal power and antenna isolation. As a result, aiming the donor antenna (to optimize the link to the network base station, and then placement and orientation of the coverage antenna (to provide satisfactory coverage and antenna isolation) can be accomplished by reference to the display 26 provided on the adaptive repeater module 12. All customization and parameter settings required for successful run-time operation of the repeater system are provided by -the personality module 14.
Provisioning all of the high-level repeater functionality on the personality module 14 creates the possibility of entirely new business models. For example, if a subscriber wishes to change carriers and/or services, then this change can be accommodated by simply providing the subscriber with a new personality module 14. No further adjustment of the repeater system is required. In another example, a personality module 14 may be configured to provide service (that is, repeater functionality) for a predetermined period of time, after which, the subscriber is required to purchase a new personality module 14 to continue to use the repeater. This replaces the traditional one-time purchase relationship between the customer and the supplier of the repeater, enabling the provisioning of the repeater as a “service” to which the customer subscribes. In a still further example, a subscriber can be provided with software updates, and thus enhancements in the functionality of their repeater system, by the simple expedient of providing new personality modules 14 to the subscriber, as required.

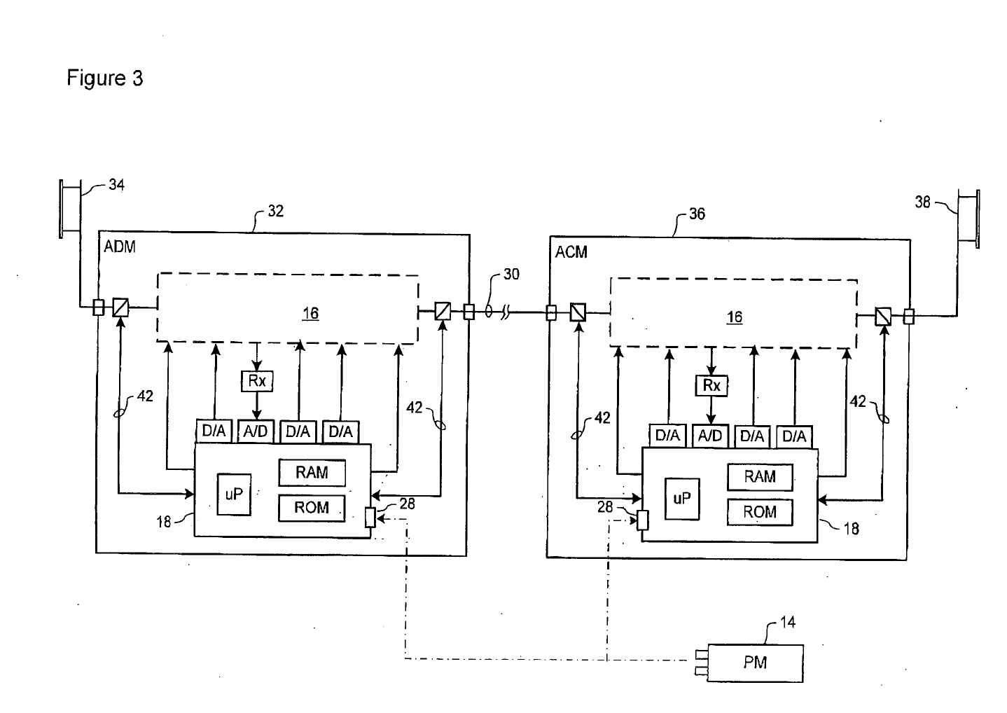

In the embodiment of FIG. 2, the adaptive repeater system is provided as a single adaptive repeater module 12 coupled between a pair of antennas. FIGS. 3-8 illustrate embodiments in which multiple adaptive repeater modules 12 are coupled together by a passive link, and operate cooperatively to provide the repeater functionality.

As shown in FIG. 3, a pair of adaptive repeater modules 12 are coupled together by a passive link 30, such as for example a length of co-axial cable. Each adaptive repeater module 12 is substantially identical, except that one, which is referred to herein as an adaptive donor module (ADM) 32, is connected to a donor antenna 34 which faces a base station of the wireless network. The other module, which is referred to herein as an adaptive coverage module (ACM) 36, is connected to a coverage antenna 38 which radiates RF signals into a coverage area of the repeater system.

In order to enable cooperative operation between the ADM 32 and ACM 36, a dedicated control channel is provided between the two modules. Various signalling protocols may be used for this purpose, such as, for example, the standard IEEE 802.15.4, which can readily be routed through the passive link 30. Ideally, the control channel operates at a frequency that does not overlap the pass band of the hardware signal path 16. Otherwise interference between the control channel signalling and the RF signals traversing the repeater system can be readily avoided using techniques well known in the art such as collision sensing or detection.

As may be seen in FIG. 3, a common personality module 14 can be used to supply performance lists and high-level software for both modules 32, 36. In this case, it is useful to tag each performance list and high-level software component with an identifier which indicates whether the respective list/component will be used by the ADM 32, the ACM 36, or both. This enables the firmware of the module that has detected insertion of the PM 14 to locate, load and execute only those performance list(s) and software components appropriate to it. Additionally, the firmware can also operate to transmit the performance list(s) and high-level software stored on the PM 14, through the control channel to the other module. When that module receives the performance list(s) and high-level software through the control channel, firmware executing in the controller unit 18 can use the identifiers to select, load, and trigger execution of the appropriate performance list(s) and software components. With this arrangement, the appropriate performance list(s) and high-level software can be loaded into both ADM 32 and ACM 36 modules, by plugging the personality module 14 into either one of the modules.

If desired, the personality module 14 may also be provided with a version identifier, which can be conveyed through the control channel along with the performance list(s) and high-level software. By this means, when a “new” personality module is plugged into either the ADM 32 or the ACM 36, the firmware of that module 14 can compare the version identifier of the personality module against the respective version identifier of any performance list(s) and high-level software that is/are already loaded and running. Based on the comparison result, the firmware can decide whether or not to load the performance list(s) and software from the “new” personality module 14. By this means, the performance list(s) and high-level software controlling the repeater system can be updated, without requiring a shut-down and re-start, merely by plugging a new personality module 14 into the PM 28 port of either one of the ADM 32 or ACM 36 modules. In addition, if the other repeater module also has a personality module 16 plugged into it, then the system will automatically load and execute the most up-to-date version of the performance list(s) and high-level software.

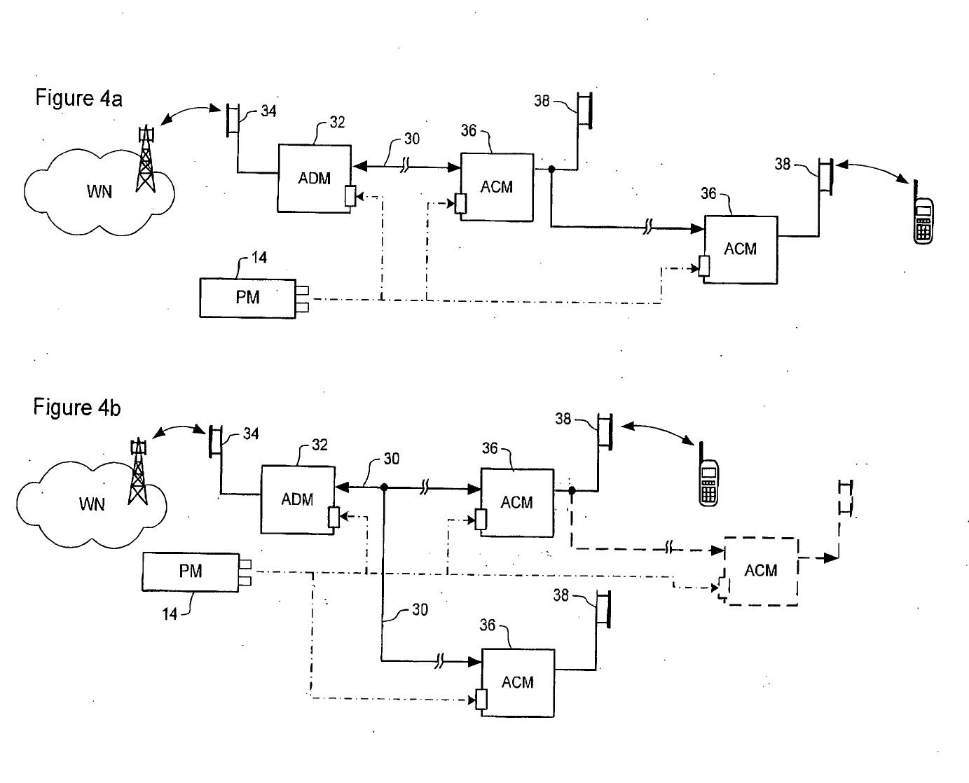

FIGS. 4a and 4b show respective embodiments in which the adaptive repeater system is made up of multiple ACMs 36 coupled to a single ADM 32. In the arrangement of FIG. 4a, two ACMs 36 are cascaded in series. As shown in FIG. 4b, ACMs 36 can also be connected to the ADM 32 in parallel, to form a “star” or “wheel-and-spoke” network pattern, By repeating the control channel messages at each module, any number of ACMs can, in principal, be connected to the ADM 32, subject primarily to the addressing limitations of the control channel signalling protocol, and the power capacity of the ADM. As will be appreciated, connection of multiple ACMs 36 to a single ADM 32 in this manner provides a convenient means of extending the coverage area of the adaptive repeater system as a whole.

Automatic detection, distribution and loading of parameter list(s) and high-level software operates in the same manner as described above with reference to FIG. 3, so that system boot-up and software updates can be accomplished using a single PM 14 plugged into the ADM 32 or any of the ACMs 36 of the repeater system. Because each ACM 36 runs its own copy of the high-level software, it is effectively semi-autonomous; optimizing its performance for the particular RF environment in which it is located. However, through the use of control channel signalling, ACMs 36 can communicate, and thus can coordinate their behaviour to actively manage the RF environment within the coverage area. This may, for example, include coordinating settings to maximize the overall coverage area.

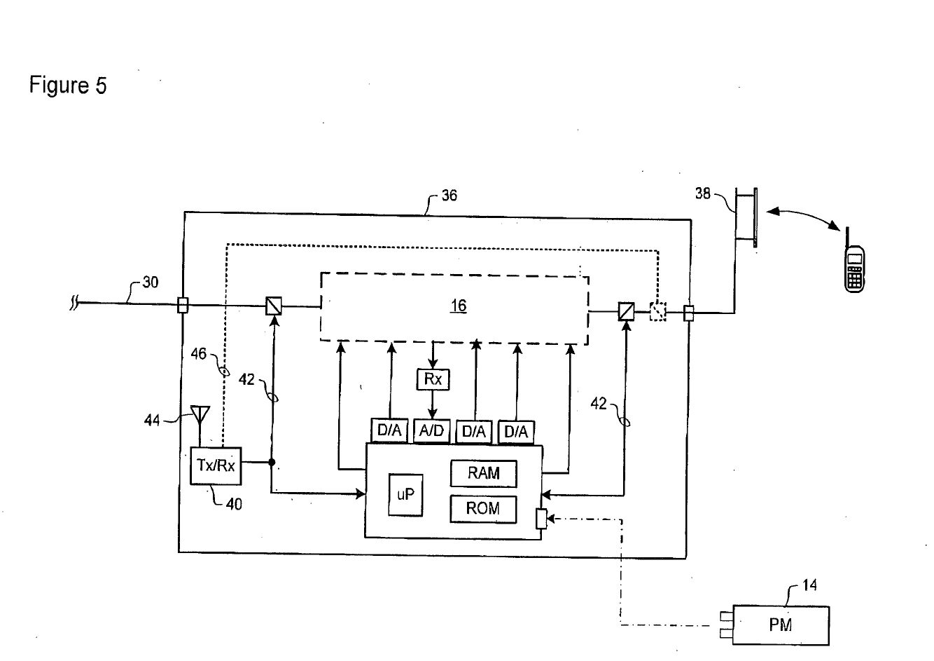

FIG. 5 illustrates an embodiment of an ACM, which includes a control channel transceiver 40, which may be coupled to the control channel bus 42 (as shown) or to the control unit 18. In either case, the control channel transceiver 40 is designed to facilitate over-the-air control channel signalling between the adaptive repeater system and a remote device. Known transceivers which may be used for this purpose include Infra-Red (IR) or RF (e.g. unlicensed 2.5 GHz) data transceivers, both of which offer low-cost solutions for over-the-air data transmission. In cases where the control channel transceiver uses an RF band for over-the-air signalling, the transceiver 40 may be connected to either a dedicated antenna 44, or to the coverage antenna 38 (as indicated by the dotted line 46 if FIG. 5) so as to facilitate control channel signalling with a remote device located anywhere within the coverage area of the ACM 36.

The control channel transceiver 40 (and/or the controller unit 18) may also be provided with an authentication system, to prevent unauthorized access (i.e. hacking) to the control channel. Various authentication methods known in the art may be used for this purpose.

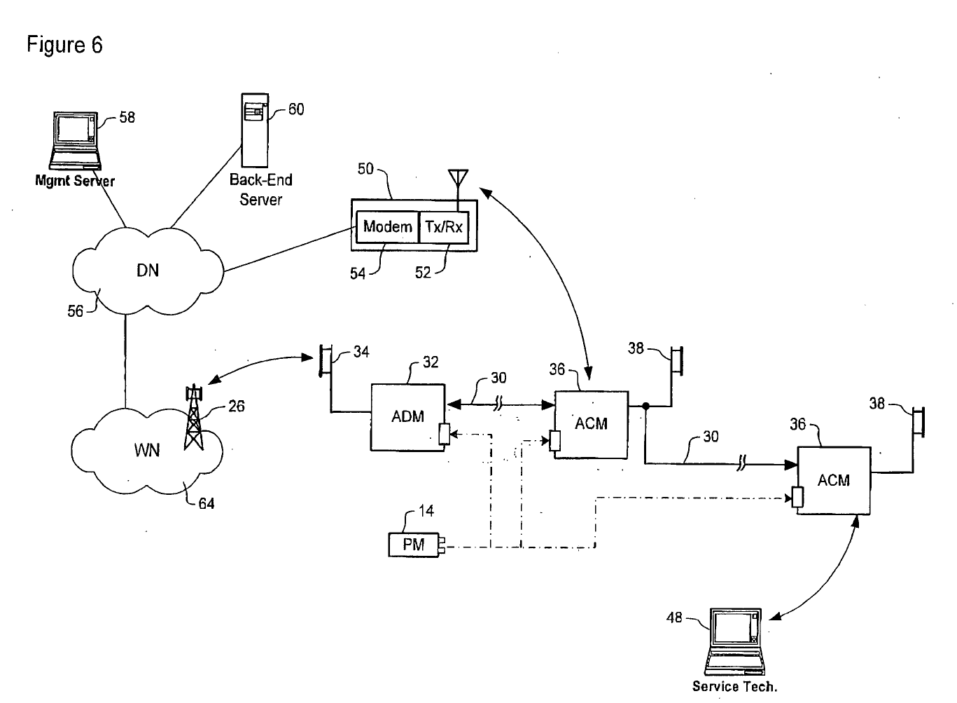

As may be seen in FIG. 6, the remote device may, for example, be a wireless (or IR) enabled computer 48 located within range (e.g. within the same room) of the control channel transceiver 40. Suitable system management software executing in the computer 48 can be used by a service technician to perform any desired system administrations functions including, for example: fault diagnosis and resolution; evaluate system status; install updates of low-level firmware, high-level software and/or parameter lists etc.

Alternatively, the remote device may, for example, be a network interface module (NM) 50 comprising a transceiver 52 for over-the-air control channel signalling with the ACM, and a modem 54 coupled to the transceiver 52 and a data network 56 (such as a Local Area Network or the internet). With this arrangement, the NM 50 can mediate control channel signalling between the adaptive repeater system and a site on the data network. Such a site may include a centralized management server 58 operated by a network (and/or repeater) service provider, either alone or in combination with a back-end server 60 which may, for example, be used to store software, firmware and parameter list updates. With this arrangement, repeater system administration functions can be provided through the data network 56, thereby greatly reducing the need for a service technician to visit a customer's premise in order to provide system administration services.

In the foregoing discussion, the control channel transceiver 40 is located within the (or each) ACM 36 of the adaptive repeater system. However, it will be appreciated that the control channel transceiver 40 may equally be located within the ADM 32. In this case, it may be convenient to use an RF transceiver which is connected to the donor antenna 34, so that control channel signalling can be radiated back to the base station 62 of the wireless network 64. This arrangement provides an alternative method of remote system management, by enabling the control unit 18 of the ADM 32 to negotiate a connection with the centralized management server 58, via the wireless and data networks 64 and 56.

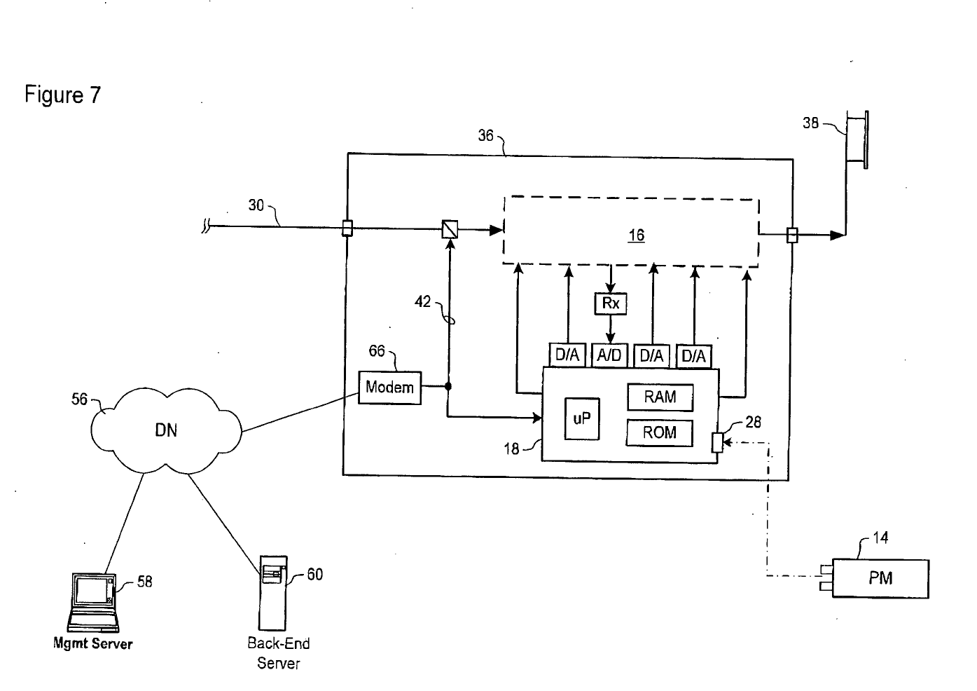

FIG. 7 illustrates a further alternative embodiment, in which the control channel transceiver is replaced by a (wire-line) modem 66 coupled to the data network 50. In this case, a connection with the centralized system management server 58 via the data network 56, can be set up without requiring an over-the-air link to a Network Interface 50.

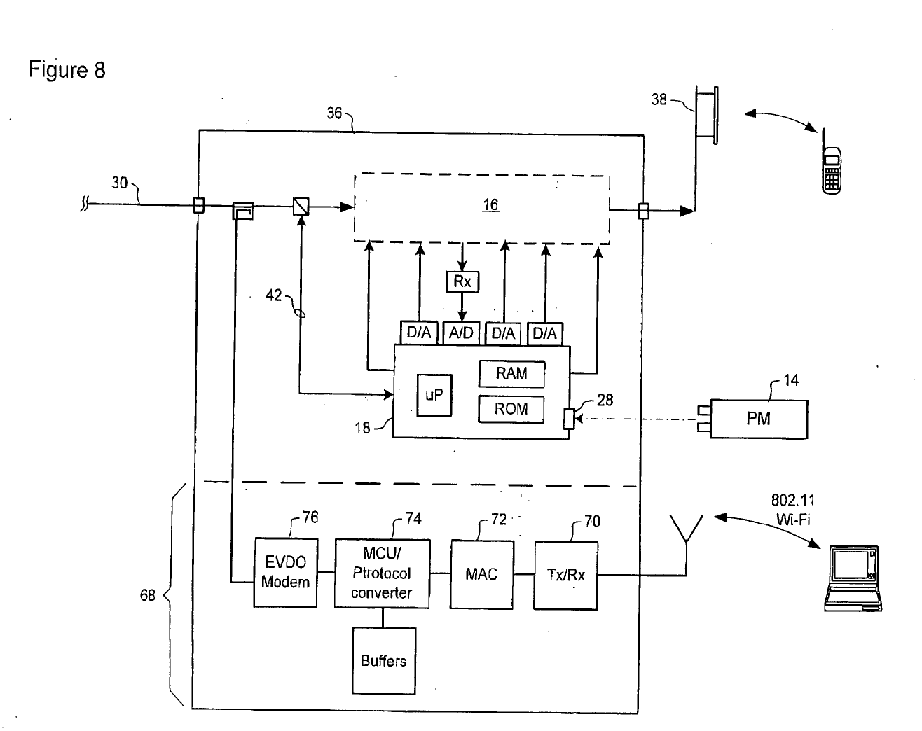

FIG. 8 illustrates a further embodiment of the present invention, in which an ACM 36 is integrated with a wireless Local Area Network (Wi-LAN) access point 18. In this case, a Wi-LAN transceiver 70 facilitates wireless data communication within the coverage area of the repeater using any of a variety on known protocols, such as for example IEEE 802.11.x. Such transceivers 70 are well known in the art. A Media Access controller (MAC) 72, MCU/protocol converter 74, and EVDO modem 76 (all of which are known in the art) coupled to the passive link 30 then enables Wi-Fi data communications back to the data network 56 (i.e. the Internet in this case) via the ADM 32 and the wireless network 64. This arrangement effectively establishes a “Wi-Fi Hot-spot” within the coverage area of the adaptive repeater system, which operates in parallel with (more traditional) cellular communications signalling. Integration of the Wi-LAN access point 68 into the ACM 36 leverages the gain control, noise management and RF signal processing functionality of the adaptive repeater system to deliver high quality RF signals to the EVDO modem 76, which enables the EVDO modem 76 to operate at or near maximum data rates necessary to backhaul with traffic.

The embodiment(s) of the invention described above is(are) intended to be exemplary only. The scope of the invention is therefore intended to be limited solely by the scope of the appended claims.

I claim:

1. A repeater system of a wireless network, the repeater system comprising:
at least one adaptive repeater module including:
a hardware signal path for processing an input RF signal to generate a corresponding output RF signal;
a controller unit including a micro-processor for controlling parameters of the hardware signal path in accordance with a software program; and
a personality module removably connectable to the adaptive repeater module, the personality module comprising a computer readable medium for storing the software program.

2. A repeater system as claimed in claim 1, wherein the parameters of the hardware signal path comprise any one or more of:
a gain of the hardware signal path;
center frequency of a pass-band of the hardware signal path;
a bandwidth of the hardware signal path pass-band;
a stability margin of the repeater system;
a frequency offset between the input signal and the output signal;

3. A repeater system as claimed in claim 1, wherein the controller unit is operative to detect a presence of the personality module, and automatically load the software program.

4. A repeater system as claimed in claim 1, wherein the personality module comprises an authorization engine for verifying whether of not the repeater system us authorized to use the software.

5. A repeater system as claimed in claim 4, wherein the authorization engine is operative to verify whether of not the repeater system us authorized to use the software based on any one or more of:
a device identifier of the repeater system;
a predetermined expiry date;
a predetermined authorization period.

6. A repeater system as claimed in claim 1, comprising a plurality of adaptive repeater modules coupled together by a passive link for bi-directional RF communications, the plurality of adaptive repeater modules comprising:
an adaptive donor module (ADM) having its respective hardware signal path coupled to the passive link and to a donor antenna for RF communications with a base station of the wireless network; and
one or more adaptive coverage modules (ACMs) having its respective hardware signal path coupled to the passive link and to a respective coverage antenna for RF communications with wireless terminal devices within a coverage area of the repeater system.

7. A repeater system as claimed in claim 6, wherein two or more adaptive coverage modules (ACMs) are cascaded in series.

8. A repeater system as claimed in claim 6, wherein two or more adaptive coverage modules (ACMs) are connected to the ADM in parallel.

9. A repeater system as claimed in claim 6, wherein the controller unit of each adaptive repeater module is operative to detect a presence of the personality module, and automatically load the software program.

10. A repeater system as claimed in claim 9, wherein the respective controller unit of each adaptive repeater module is coupled to the passive link for bi-directional communications using a predetermined control channel.

11. A repeater system as claimed in claim 9, wherein the personality module contains software program code for each adaptive repeater module of the repeater system, and wherein the controller unit of each adaptive repeater module is operative to transmit the software program code to each one of the other adaptive repeater modules of the repeater system, via the control channel.

12. A repeater system as claimed in claim 11, wherein the personality module contains a version code associated with the software program stored in the computer readable medium, and wherein the controller unit is operative to transmit the version code to each one of the other adaptive repeater modules of the repeater system, via the control channel.

13. A repeater system as claimed in claim 11, wherein the controller unit of each adaptive repeater module is operative to:
compare the respective version code of a local personality module with a version code received through the control channel; and
load the software program associated with the most recent version code.

14. A repeater system as claimed in claim 1, wherein the adaptive repeater module further comprises a control channel transceiver adapted to enable control channel signaling between at least the controller unit and a remote device.

15. A repeater system as claimed in claim 14, wherein the control channel transceiver is connected to either one of:
a control channel bus of the adaptive repeater module; and
the controller unit.

16. A repeater system as claimed in claim 14, wherein the control channel transceiver comprises either one or both of:
an RF transceiver; and
an infra-red transceiver.

17. A repeater system as claimed in claim 16, wherein the RF transceiver comprises an independent antenna for radiating control channel signalling within an immediate vicinity of the adaptive repeater module.

18. A repeater system as claimed in claim 16, wherein the RF transceiver is connected to a main antenna coupled to the hardware signal path for radiating the output RF signals to a coverage area of the adaptive repeater module, such that the main antenna also radiates control channel signaling within the coverage area of the adaptive repeater module.

19. A repeater system as claimed in claim 18, wherein the coverage area of the adaptive repeater module includes a base station of the wireless network, wherein the remote device is a site on a data network accessible via the wireless network, and wherein the control channel transceiver is operative to negotiate a connection between the adaptive repeater system and the remote site via the wireless network and the data network.

20. A repeater system as claimed in claim 16, wherein the remote device is a wireless-enabled computer.

21. A repeater system as claimed in claim 20, wherein the wireless-enabled computer includes a respective computer readable medium storing a repeater system management program, and wherein execution of the repeater system management program on the computer enables a user to manage the adaptive repeater system.

22. A repeater system as claimed in claim 16, wherein the remote device is a network interface module (NM) comprising:
a transceiver enabling over-the-air control channel signaling with the adaptive repeater module; and
a modem coupled to the transceiver and a data network;
wherein the wireless transceiver and modem cooperate to enable control channel signaling between the adaptive repeater module and a remote site on the data network.

23. A repeater system as claimed in claim 22, wherein the remote site on the data network comprises any one or more of:
a remote repeater management server; and
a back-end server.

24. A repeater system as claimed in claim 22, wherein the network interface module transceiver comprises either one or both of:
an RF transceiver; and
an infra-red transceiver.

25. A repeater system as claimed in claim 22, wherein the modem comprises any one or more of:
a dial-up modem;
a cable modem; and
a DSL modem.

26. A repeater system as claimed in claim 14, wherein the control channel transceiver comprises a modem coupled to a data network, and wherein the remote device is any one or more of:
a remote repeater management server; and
a back-end server.

27. A repeater system as claimed in claim 14, wherein adaptive repeater module further comprises means for preventing unauthorized access to the control channel.
